(19) United States
(12) Patent Application Publication
(10) Pub. No.: US 2013/0239943 A1
(43) Pub. Date: Sep. 19, 2013

(54) Mounting Apparatus For Attaching A Heating Device To A Tabletop

(71) Applicant: Charles Michael James, Antioch, TN (US)

(72) Inventor: Charles Michael James, Antioch, TN (US)

(21) Appl. No.: 13/422,834

(22) Filed: Mar. 16, 2012

(51) Int. Cl. F24C 1/00; B23P 19/04; F16M 13/02

(52) U.S. Cl. 126/58; 248/674; 29/525.01

(57) ABSTRACT

A heater apparatus mounted on a tabletop using an existing hole in the tabletop, such as an umbrella hole, includes a clamp shaft shaped for insertion through the hole. A clamp plate extends generally radially from the clamp shaft. An energy supply line, such as an electrical cord or a fuel hose, extends from a heating unit above the tabletop through an axial bore in the clamp shaft to a location below or near the table for attachment to an external energy source such as an electrical outlet or a fuel tank. One or more clamp plates may be positioned on the clamp shaft to stabilize the heating apparatus by applying a clamping force against the tabletop. A clamp fastener may also be disposed on the clamp shaft for applying a clamping force against the table between the clamp plates.

### BACKGROUND

1. Technical Field

The present invention relates generally to outdoor furniture and more particularly to heating devices for patio furniture.

2. Related Art

Outdoor heaters are generally known in the art and include a heating unit supported by a pole. The pole is typically mounted on a base that rests against a surface such as the ground. Conventional outdoor heating devices are known to operate using either electricity or combustion of liquid or gas fuel to generate heat. Conventional outdoor heaters are commonly used on outdoor patios at homes and commercial business such as restaurants. Restaurants and other businesses often experience reduced demand for outdoor seating during winter months due to uncomfortable weather outside. To overcome this, outdoor heaters are commonly placed at various locations in outdoor environments to provide heat. However, a problem arises when one or more tables are positioned in the same environment as outdoor heaters. An outdoor heater positioned beside a table will typically generate more heat on the side of the table nearest the heater. As a result, the individuals seated nearest the heater will feel warmer than the individuals sitting farthest from the heater. This can cause an uncomfortable environment. Conventional free-standing outdoor heaters are generally not configured to be positioned on a table. Such heaters are often too large to fit on a table without taking up an undesirable amount of space on the table.

Others have attempted to solve the problems associated with conventional outdoor heaters by providing smaller heating devices that may sit directly on top of a table. By positioning a heating device on the table, heat may be more evenly distributed to the individuals sitting around the table. However, such conventional tabletop heating devices that operate using a liquid or gas fuel are limited by the amount of fuel that can be contained in the tabletop device. It is generally undesirable for such tabletop heating devices to include a large reservoir of fuel when placed on a tabletop. Thus, conventional tabletop heating devices typically include relatively small fuel containers that may be quickly depleted during use. The short burn times associated with conventional small fuel reservoirs cause users to need to frequently refill or replace the fuel containers in such conventional devices.

Additionally, conventional tabletop heating devices often do not produce the amount of heat that can be generated by larger floor-mounted outdoor heaters and may be inadequate for heating larger tables or larger spaces.

What is needed, then, are improvements in devices and methods for mounting a heating device on a tabletop.

### BRIEF SUMMARY

In some embodiments, the present disclosure provides a heater apparatus for attachment to a conventional tabletop, the tabletop having an opening defined therein. The tabletop may include a tabletop on a conventional patio table, and the hole may include an umbrella hole in some applications. The heater apparatus is configured to be mounted on the tabletop using the existing umbrella hole opening as a mounting hole. As such, the present disclosure also provides devices and methods for retrofitting a conventional table having a hole defined therein, such as an umbrella hole, to include a heater mounted thereon.

In additional embodiments, the present disclosure provides a mounting apparatus for securing a heating unit to a table. The mounting apparatus includes a clamping post having a clamp head and a clamp shaft extending downwardly from the clamp head. The clamp shaft includes a threaded portion dimensioned for insertion through the hole in the tabletop. The heating unit is mounted on a support pole in some embodiments. The clamp head is attached to the support pole such that the clamp shaft extends downwardly from the support pole. The support pole may include a hollow support bore, and a power supply line extends from the heating unit downwardly through the hollow support bore. Thus, the energy supply line, which may include an electrical line or a fuel supply hose, may be hidden from view. The energy supply line may be connected to an energy source located underneath the table or located near the table, such as a fuel tank or an electrical outlet, to supply fuel or electricity to the heating unit.

In some embodiments, the present disclosure provides an apparatus for mounting a heating unit supported by a support pole to a tabletop, the tabletop having a first surface and a second surface, and the tabletop including a hole extending through the tabletop from the first surface to the second surface. The apparatus includes a clamping post having a clamp head and a clamp shaft, the clamp shaft extending downwardly from the clamp head, the clamping post defining a shoulder between the clamp head and the clamp shaft. A first clamp plate is co-axially disposed on the clamp shaft wherein the shoulder rests against the first clamp plate, the first clamp plate extending radially beyond the outermost dimension of the clamp head. A second clamp plate is co-axially disposed on the clamp shaft below and in spaced relation to the first clamp plate, the second clamp plate extending radially beyond the outermost dimension of the clamp head. The first and second clamp plates are configured to clamp the tabletop therebetween.

In another embodiment, the present disclosure provides a heater apparatus for mounting to a tabletop via a hole in the tabletop, the hole including an inner hole diameter. The apparatus includes a heater unit configured to emit heat to an environment surrounding the heater unit. A support pole extends downwardly from the heater unit. A clamping post is disposed on the support pole. The clamping post includes a clamp head attached to the support pole and a clamp shaft extending downwardly from the clamp head, the clamp shaft dimensioned to fit through the hole in the tabletop. A first clamp plate is disposed on the clamping post below the clamp head, the first clamp plate including a first plate aperture defined therein. The first clamp plate includes an outer diameter greater than the inner hole diameter, and the clamp shaft extends through the first plate aperture. A clamp fastener is disposed on the clamp shaft below the first clamp plate.

In additional embodiments, the present disclosure provides a method of attaching a heater apparatus to a tabletop, the tabletop including a hole in the tabletop, the hole including an inner hole diameter, the method comprising the steps of: (a) providing a heater apparatus including a heating unit attached to a support pole extending downwardly therefrom, the support pole including a threaded clamp shaft protruding from the support pole, the clamp shaft including a clamp plate disposed thereon, the clamp plate including an outer plate diameter greater than the inner hole diameter; (b) inserting the clamp shaft through the hole in the tabletop such that a portion of the clamp shaft extends below the tabletop; and (c) securing a clamp fastener to the portion of the clamp shaft extending below the tabletop.

A further embodiment of the present disclosure provides an apparatus for mounting a heating unit supported by a support pole to a tabletop, the tabletop having a first surface and a second surface, the tabletop including a hole extending through the tabletop from the first surface to the second surface. The apparatus includes a first clamp plate having a larger outer dimension than the inner diameter of the hole and a clamp shaft extending axially from the first clamp plate, the clamp shaft being shaped for clearance insertion through the hole in the tabletop. An axial bore is defined through the clamp shaft, and a second clamp plate configured for attachment to the clamp shaft, the second clamp plate having a larger outer dimension than the inner diameter of the hole. A second clamp plate aperture is defined through the second clamp plate, the second clamp plate aperture shaped for receiving the clamp shaft. The first clamp plate is configured to apply a compressive force against the first surface of the tabletop and the second clamp plate is configured to apply a compressive force against the second surface of the tabletop.

Another object of the present disclosure is to provide a heater apparatus that can be mounted in an umbrella hole in a tabletop.

A further object of the present disclosure is to provide an apparatus for retrofitting a conventional table having a pre-existing opening defined therein, such as an umbrella hole, to include a heating unit mounted through the opening.

Another object of the present disclosure is to provide an apparatus for evenly heating the environment around a table from above.

Yet another object of the present invention is to provide a heating apparatus for attachment to a patio table via an umbrella opening.

Numerous other objects, features and advantages of the present disclosure will be readily apparent to those skilled in the art upon a reading of the following description when taken in conjunction with the accompanying drawings.

### BRIEF DESCRIPTION OF THE DRAWINGS

FIG. 1 illustrates a partially exploded perspective view of an embodiment of a heater apparatus positioned for installation on a tabletop in accordance with the present disclosure.

FIG. 2 illustrates a perspective view of an embodiment of a table assembly including a heating apparatus mounted to a tabletop in accordance with the present disclosure.

FIG. 3 illustrates an exploded perspective view of an embodiment of a heater apparatus in accordance with the present disclosure.

FIG. 4 illustrates partial cross-sectional elevation view of an embodiment of a heating apparatus mounted to a tabletop in accordance with the present disclosure.

FIG. 5 illustrates a detail cross-sectional view of an embodiment of a mounting apparatus attached to a tabletop in accordance with the present disclosure.

FIG. 6 illustrates a perspective view of an embodiment of a clamping post in accordance with the present disclosure.

FIG. 7 illustrates a perspective view of an embodiment of a first clamp plate in accordance with the present disclosure.

FIG. 8 illustrates a perspective view of an embodiment of a second clamp plate in accordance with the present disclosure.

FIG. 9 illustrates a partial cross-sectional view of an embodiment of a heating apparatus mounted to a tabletop in accordance with the present disclosure.

FIG. 10 illustrates a side elevation view of an embodiment of a heating device in accordance with the present disclosure.

FIG. 11 illustrates a partial cross-sectional view of an embodiment of a heating device in accordance with the present disclosure.

FIG. 12 illustrates an elevation view of an embodiment of a heating apparatus in accordance with the present disclosure.

FIG. 13 illustrates a partial cross-sectional view of an embodiment of a mounting apparatus in accordance with the present disclosure.

FIG. 14 illustrates a partial cross-sectional view of an embodiment of a mounting apparatus in accordance with the present disclosure.

FIG. 15 illustrates a partial cross-sectional view of an embodiment of a mounting apparatus in accordance with the present disclosure.

FIG. 16A illustrates a perspective view of an embodiment of a centering cone in accordance with the present disclosure.

FIG. 16B illustrates a perspective view of an embodiment of a centering cone in accordance with the present disclosure.

FIG. 17 illustrates a perspective view of an embodiment of a heater apparatus positioned for installation on a tabletop mounting apparatus in accordance with the present disclosure.

FIG. 18 illustrates a partial cross-sectional view of an embodiment of a mounting apparatus in accordance with the present disclosure.

### DETAILED DESCRIPTION

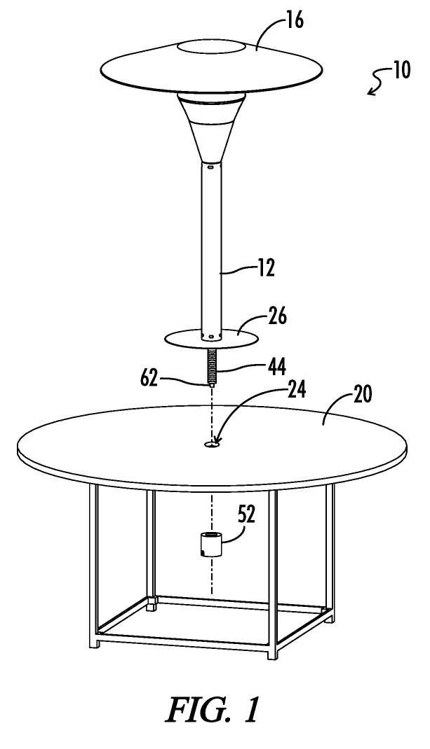

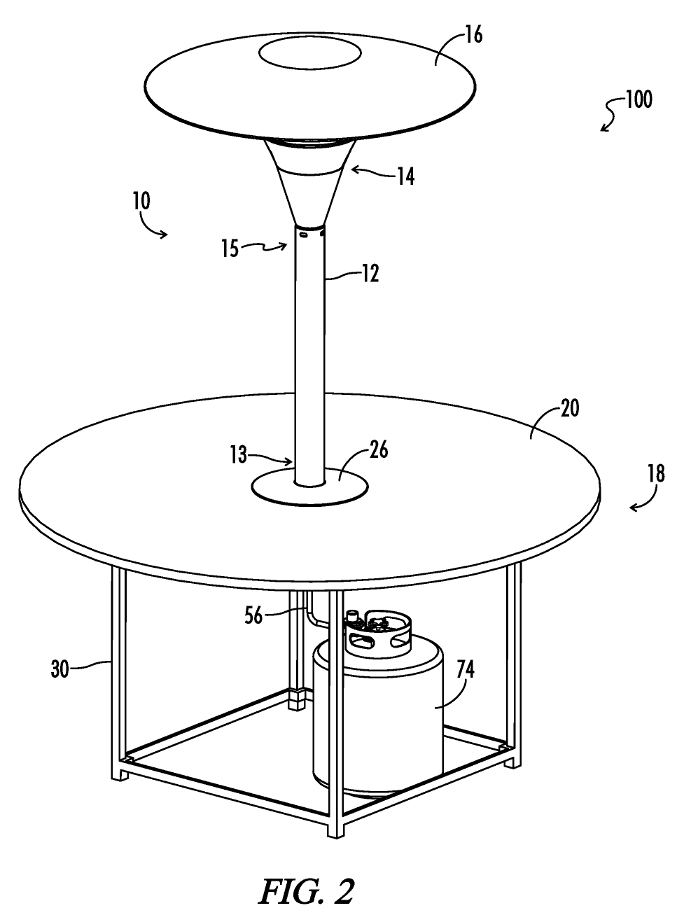

Referring now to the drawings, FIG. 1 illustrates an exemplary embodiment of a heater apparatus 10 positioned for installation onto a tabletop 20. Tabletop 20 generally includes a tabletop having a hole 24 defined therein. Hole 24 may include a conventional umbrella hole in some embodiments. Heater apparatus 10 includes a first clamp plate 26 having a first clamp flange portion extending radially outwardly therefrom. The first clamp plate also includes a clamp shaft 44 extending axially from the first clamp plate 26. Clamp shaft 44 is shaped for clearance insertion through the hole 24 in tabletop 20. When the heater apparatus 10 is mounted on tabletop 20, first clamp plate 26 rests against tabletop 20 and provides support for the heating apparatus 10, as seen in FIG. 2.

FIG. 2 illustrates an exemplary embodiment of a table assembly 100 including a table 18 having a tabletop 20. A heater apparatus 10 is attached to tabletop 20 such that heater apparatus 10 extends above table 18. Heater apparatus 10 includes a support pole 12 having a lower end 13 and an upper end 15 extending above the tabletop 20. Support pole 12 includes a tubular support in some embodiments. A heating unit 14 is attached to the support pole 12. Heating unit 14 may include a flame-operated heating unit in some embodiments configured to generate heat using combustion of a liquid, solid or gas fuel supplied to heating unit 14. In other embodiments, heating unit 14 may include an electric heating unit configured to generate heat using electricity. Heating unit 14 may include a deflector 16 shaped to deflect heat generally downwardly toward the tabletop.

As seen in FIG. 2, heater apparatus 10 may be stabilized relative to tabletop 20 using a first clamp plate 26 positioned at lower end 13 of support pole 12. Also seen in FIG. 2, in some embodiments, an energy source 74 such as a fuel tank may be attached to heater apparatus 10 after heater apparatus 10 is mounted on tabletop 20. In some applications, energy source 74 includes a conventional propane tank. Energy source 74 may be positioned under tabletop 20 within table frame 30 or may be located remotely from table 18. One or more panels may be attached to table frame 30 in some embodiments to enclose energy source 74 such that energy source 74 is not visible from the exterior of table apparatus 100. Energy source 74 may be described as an external energy source because it is not included on heater apparatus 10 but rather may be connected to heater apparatus 10 after heater apparatus 10 is mounted on tabletop 20.

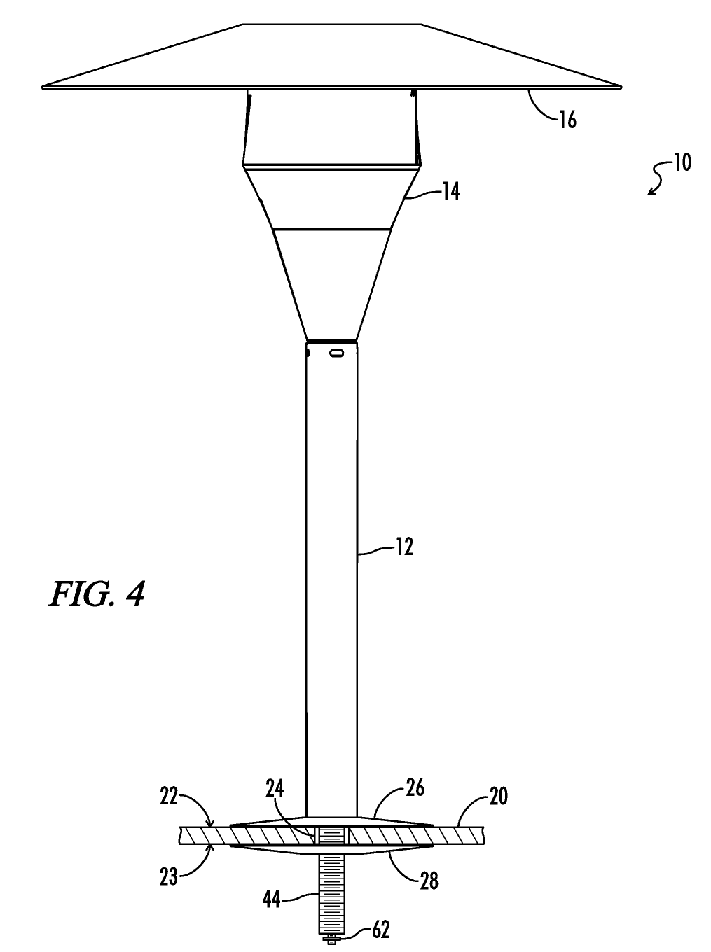

As seen in FIG. 4, a heater apparatus 10 is illustrated in a partial cross-sectional view mounted on tabletop 20. In some embodiments, heater apparatus 10 includes a clamp shaft 44 extending axially downwardly from support pole 12 and from first clamp plate 26. Clamp shaft 44 may include one or more threaded regions in some embodiments. Clamp shaft 44 is generally dimensioned to fit through an opening 24 in a tabletop. For example, in some embodiments, clamp shaft 44 is shaped for clearance insertion through the hole 24 in tabletop 20. As such, heating apparatus 10 may be mounted on a tabletop by inserting clamp shaft 44 downwardly through an existing umbrella hole in the tabletop in some embodiments.

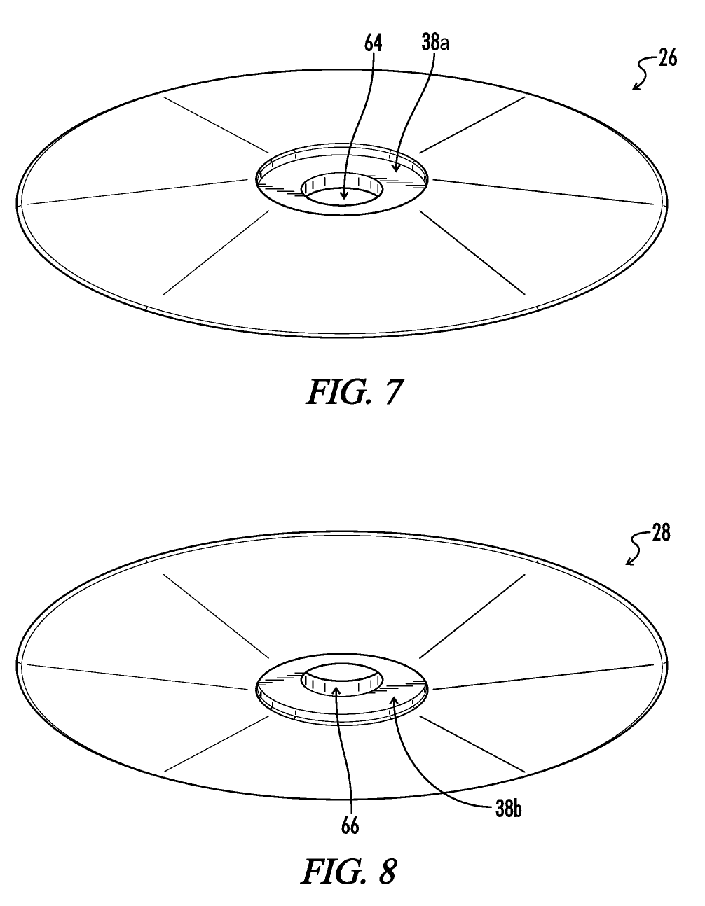

Because support pole 12 may be unstable when clamp shaft 44 is inserted through hole 24 in tabletop 20, a first clamp plate 26 may be disposed between support pole 12 and tabletop 20. First clamp plate 26 generally includes a first clamp plate outer dimension greater than the inner diameter of hole 24. As such, first clamp plate 26 rests against, either directly or indirectly, first surface 22 of tabletop 20. In some embodiments, first clamp plate 26 includes an annular disk including a first clamp plate aperture 64 defined near the center of the disk, as seen in FIG. 7. An axial bore 46 is defined through clamp shaft 44 in some embodiments.

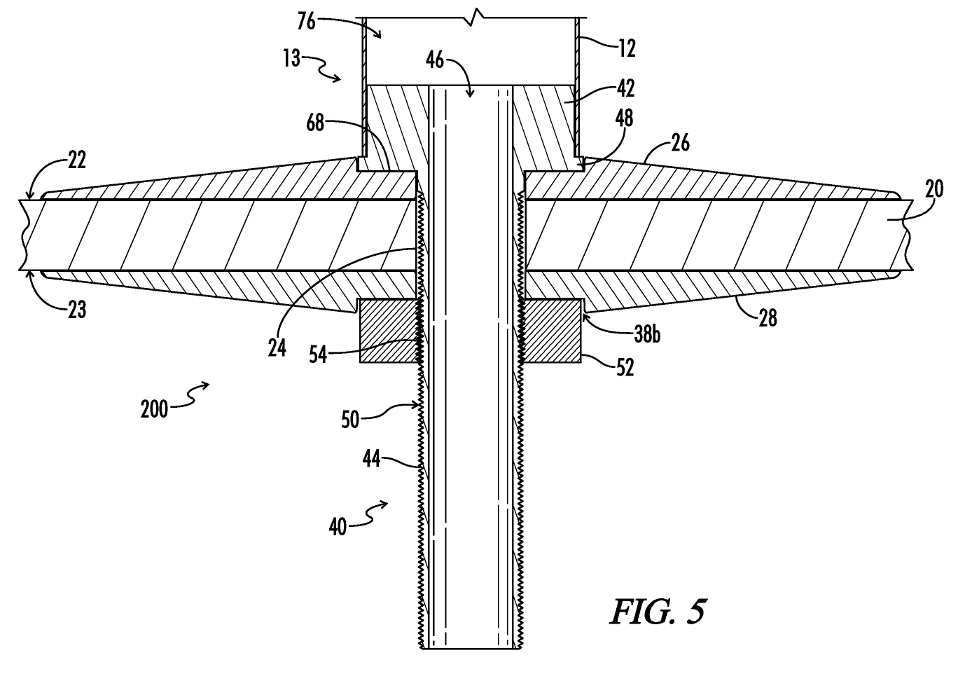

First clamp plate 26 may include a tapered thickness profile as seen in FIG. 5 such that first clamp plate 26 includes a first plate thickness near the first clamp plate aperture 64 and a second plate thickness farther away from the first clamp plate aperture 64, wherein the first plate thickness is greater than the second plate thickness.

First clamp plate 26 may be axially installed onto clamp shaft 44 by sliding clamp shaft 44 through first clamp plate aperture 64. First clamp plate 26 is installed on clamp shaft 44 prior to inserting clamp shaft 44 through hole 24 in some applications. Alternatively, first clamp plate 26 may be positioned on the first surface 22 of tabletop 20 such that first clamp plate aperture 64 is aligned with hole 24 prior to inserting clamp shaft 44 through both first clamp plate aperture 64 and hole 24.

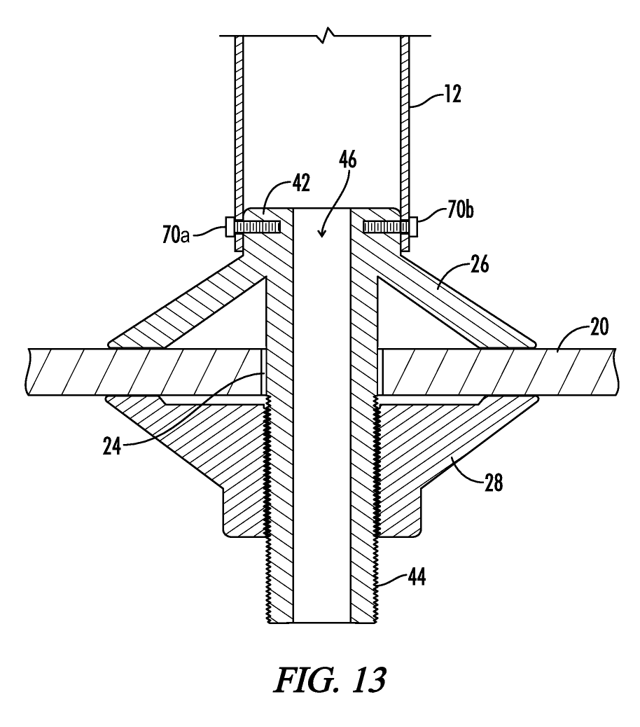

In further embodiments, such as those seen in FIGS. 13-15, first clamp plate 26 may be integrally formed on clamp shaft in a unitary construction. In various embodiments, first clamp plate 26 and clamp shaft 44 may be formed by integral molding, machining, casting, forging, welding or any other suitable process for forming a one-piece unit.

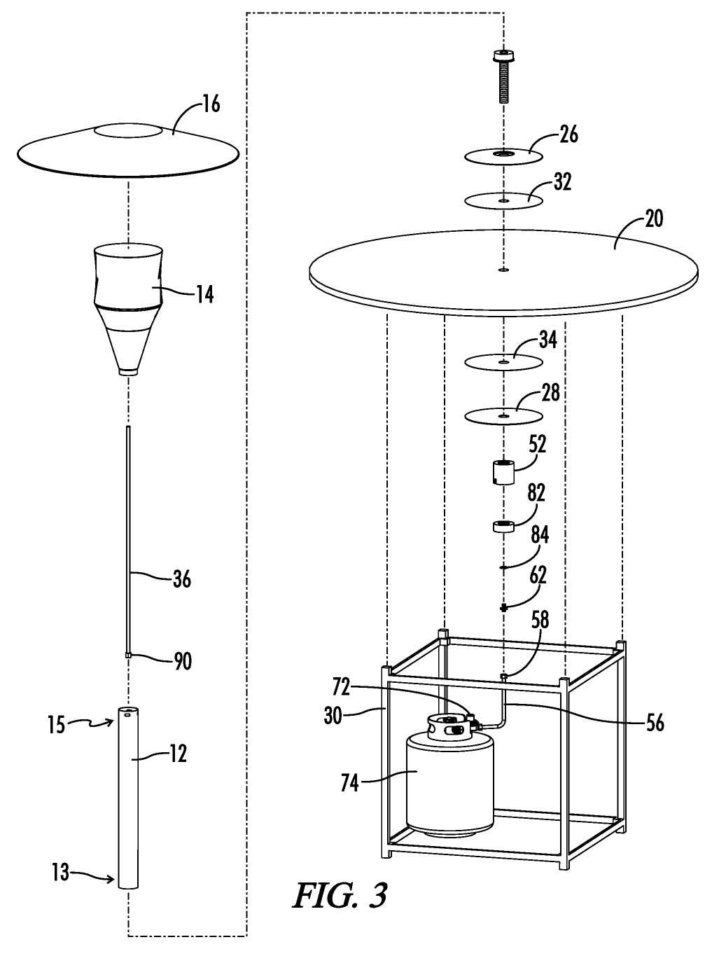

To further stabilize heating apparatus 10 when mounted on tabletop 20, as seen in FIG. 2, a second clamp plate 28 may be installed on clamp shaft 44 such that second clamp plate 28 rests against, either directly or indirectly, the second surface 23 of tabletop 20. Second clamp plate 28 in some embodiments is an inverted duplicate of first clamp plate 26, as seen in FIG. 7 and FIG. 8. By providing duplicate, or interchangeable, first and second clamp plates 26, 28 in some embodiments, manufacturing costs may be reduced. Second clamp plate 28 includes a second clamp plate aperture 66 dimensioned to receive clamp shaft 44. Second clamp plate 28 is generally installed onto clamp shaft 44 from below tabletop 20, as seen in FIG. 3, after clamp shaft 44 has been inserted through hole 24. However, in various embodiments, second clamp plate 28 may be positioned above tabletop 20, and first clamp plate 26 may be positioned below tabletop.

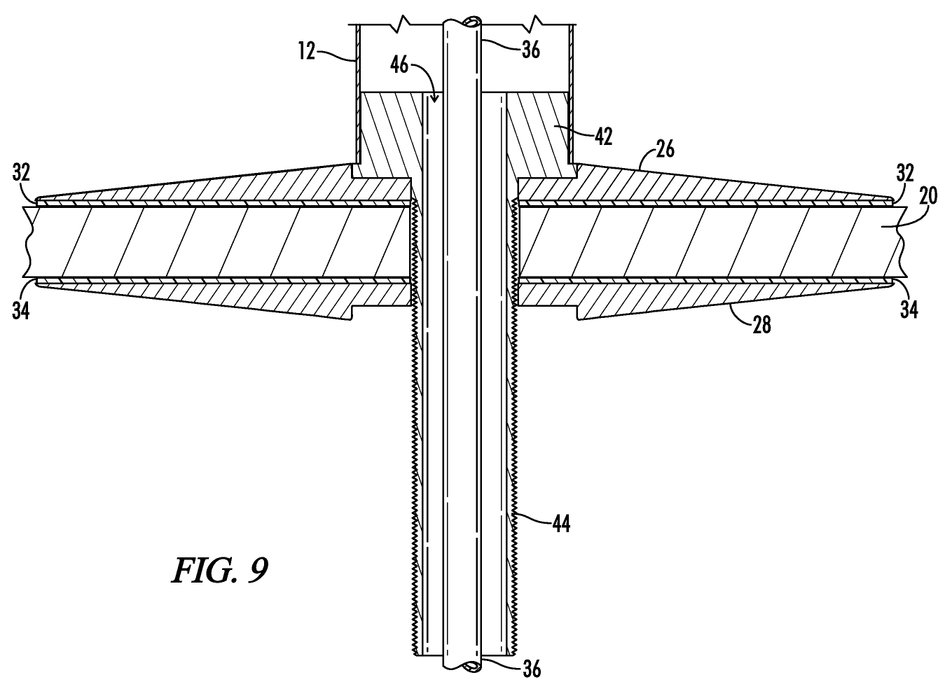

Second clamp plate 28 generally includes a clearance fit on clamp shaft 44 in some embodiments. As such, the inner diameter of second clamp plate aperture is slightly larger than the outer diameter of clamp shaft 44 such that second clamp plate 44 may be axially slid onto clamp shaft 44, as seen in FIG. 9.

However, in some other embodiments, second clamp plate 28 includes a threaded region adjacent second clamp plate aperture 66 configured to threadedly engage the shaft thread 50 on clamp shaft 44, allowing second clamp plate 28 to be screwed directly onto clamp shaft 44. In such embodiments, second clamp plate 28 may be referred to as a mounting nut or a flange nut. As such, second clamp plate 28 may be tightened against the second surface 23 of tabletop 20, thereby clamping tabletop 20 between first clamp plate 26 and second clamp plate 28. Second clamp plate 28 is configured for attachment to the clamp shaft 44 below the first clamp plate 26 in various embodiments including embodiments wherein second clamp plate 28 is axially slid onto clamp shaft 44 and embodiments wherein second clamp plate 28 threadedly engages clamp shaft 44. Second clamp plate 28 defines a second clamp plate aperture 66 defined through the second clamp plate. The second clamp plate aperture 66 is shaped for receiving the clamp shaft 44.

Referring to FIG. 4 and FIG. 5, in additional embodiments, first and second clamp plates 26, 28 are both installed on clamp shaft 44 in a clearance fit. In such embodiments, a clamp fastener 52 is attached to clamp shaft 44 below second clamp plate 28 to provide a clamping force on tabletop 20 between first and second clamp plates 26, 28. Clamp fastener 52 may include a threaded nut screwed onto clamp shaft 44 from below tabletop 20 after clamp shaft 44 has been inserted through hole 24. Clamp fastener 52 includes a fastener thread 54 configured to threadedly engage a corresponding shaft thread 50 on the outer surface of clamp shaft 44.

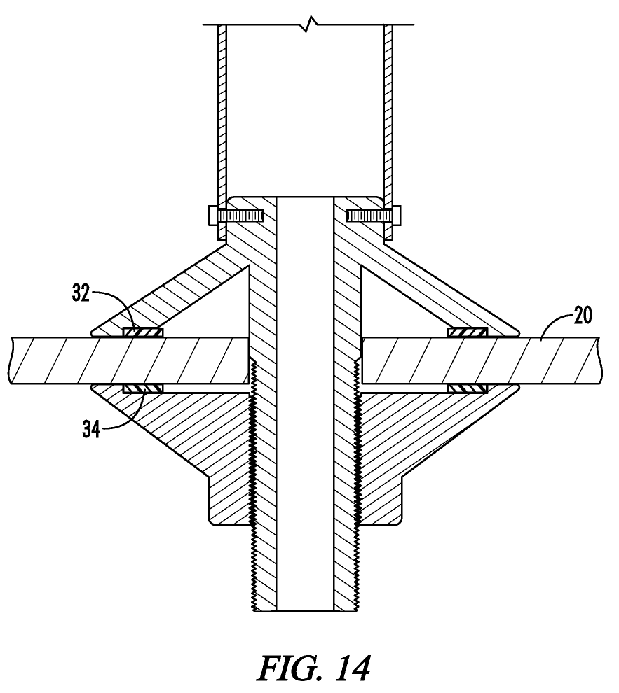

Clamp fastener 52 may be secured to second clamp plate 28 by in some embodiments such that both second clamp plate 28 and clamp fastener 52 are simultaneously installed onto clamp shaft 44. In other embodiments, clamp fastener 52 and second clamp plate 28 are separate components, and clamp fastener 52 may be screwed against second clamp plate 28 for applying a clamping force on tabletop 20 between first and second clamp plates 26, 28. In even further embodiments, second clamp plate 28 and clamp fastener 52 are integrally formed in a unitary, on-piece construction, forming a flange nut that includes both a threaded aperture and a radially extending flange for applying an axial clamping, or compressive, force against the tabletop, as seen in FIG. 14. When clamp fastener 52 is tightened against second clamp plate 28, or alternatively tightened together with second clamp plate 28 against the second surface of tabletop 20, heater apparatus 10 may be attached to tabletop 20 in a stable configuration. Clamp fastener 52 may be described as being tightened against second clamp plate 28 when clamp fastener 52 directly engages second clamp plate 28 or when an intermediate structure such as a washer or gasket is positioned between second clamp plate 28 and clamp fastener 52 such that clamp fastener 52 does not directly engage second clamp plate 28.

Referring further to FIG. 3, in some embodiments, the present disclosure provides a mounting apparatus 200 for securing a heating unit to a tabletop. The mounting apparatus 200 includes a clamping post 40, a first clamp plate 26, a second clamp plate 28, and a clamp fastener 52.

Clamping post 40 includes a clamp head 42 and a clamp shaft 44. Clamp head 42 includes a head diameter greater than the inner diameter of hole 24 in some embodiments. Clamp head 42 may be shaped to fit inside an opening at the lower end of support pole 12, as seen in FIG. 3. In some embodiments, clamp head 42 is rigidly attached to support pole. Clamp head 42 may be welded to support pole 12 or attached to clamp head 42 by another suitable mechanical engagement such as by an interference or friction fit, or by a threaded engagement in various embodiments. In additional embodiments, clamp head 42 may be secured to support pole 12 using one or more fasteners installed through support pole 12 into clamp head 42.

As seen in FIG. 5, support pole 12 includes an hollow interior space 76. Support pole 12 includes a hollow tube surrounding interior region 76 in some embodiments. Similarly, clamping post 40 includes an axial bore 46 defined axially through clamping post 40 in some embodiments. Axial bore 46 provides a passage for an energy supply line 36, seen in FIG. 9, such as an electrical conductor, an electrical cord or a fuel hose, for supplying either electrical power or fuel to the heating unit positioned at the top of support pole 12. By providing a hollow interior region 76 open to axial bore 46, an energy supply line 36 can be routed from the heating unit at the top of support pole 12 to a location underneath the tabletop. Because the energy supply line 36 may be housed within the support pole 12 and passes through the shaft 44, the line is not visible from the exterior of the apparatus and can be protected from damage.

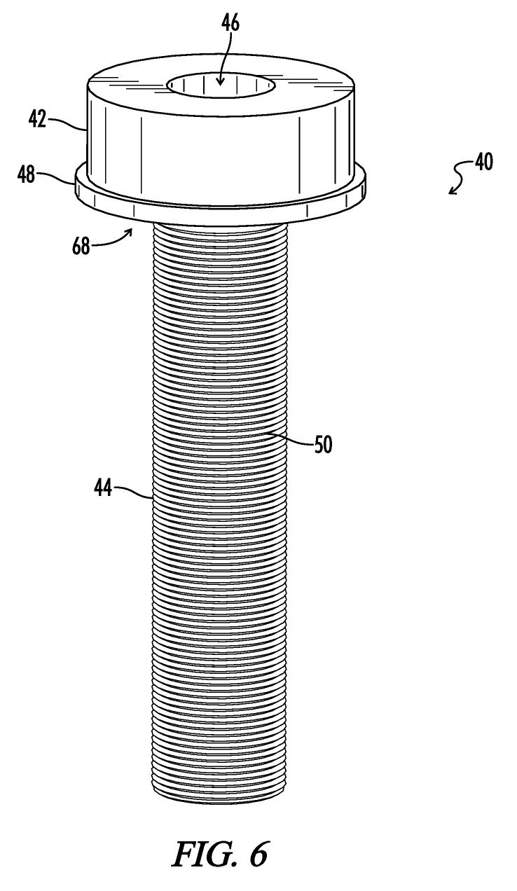

Referring further to FIG. 5 and FIG. 6, in some embodiments, a head flange 48 may extend radially from clamp head 42 on clamping post 40. Head flange 48 provides an axial stop for support pole 12 such that clamping post 40 does not advance too far into the opening in the lower end of support pole 12.

In some embodiments, the outer diameter of clamp head 42 is larger than the outer diameter of clamp shaft 44, thereby forming a shoulder 68 on clamping post 40 between clamp head 42 and mounting shaft 44. Referring to FIG. 7, a first clamp plate recess 38a may be formed on the upper side of first clamp plate 26. First clamp plate recess 38a is shaped to receive shoulder 68 on clamping post 40 in some embodiments, as seen in FIG. 5.

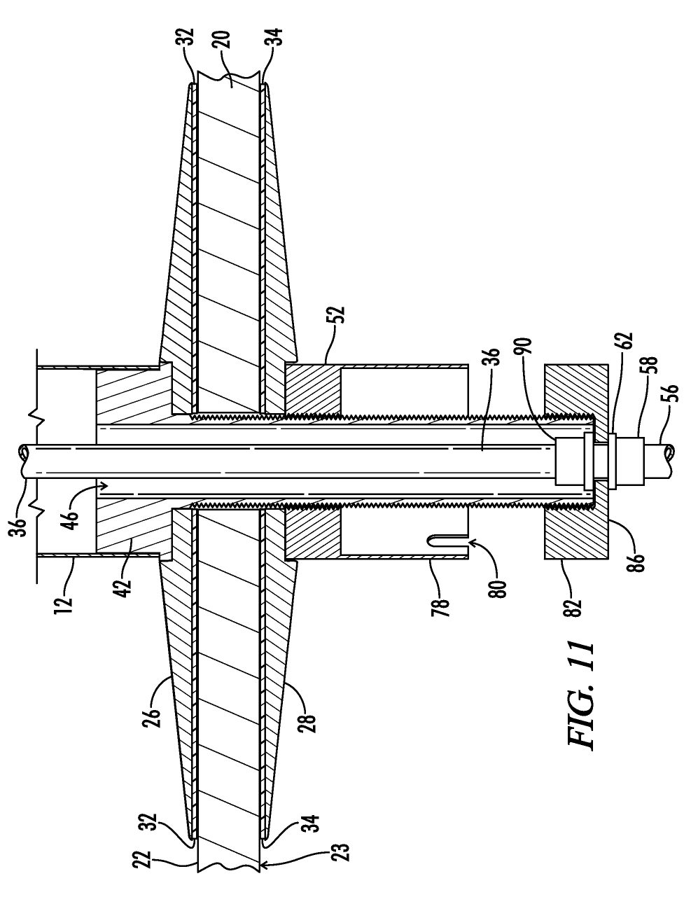

Similarly, a second clamp plate recess 38b may be formed on the lower side of second clamp plate 28, as seen in FIG. 8. In some embodiments, second clamp plate recess 38b may be shaped to partially receive clamp fastener 52, as seen in FIG. 5 and FIG. 11.

In some embodiments, first and second clamp plates 26, 28 may include a rigid material such as a metal, ceramic, tile, plastic or other suitable material. First clamp plate 26 and/or second clamp plate 28 could possibly scratch or inadvertently slide against tabletop 20 in some applications. A first pad 32 may be positioned between first clamp plate 26 and the first surface of tabletop 20 in some applications, as seen in FIG. 9. Similarly, a second pad 34 may be positioned between second clamp plate 28 and the second surface of tabletop 20 in some embodiments. First and second pads 32, 34 may include a neoprene material in some embodiments. In other embodiments, first and second pads 32, 34 may include any other materials such as but not limited to rubber, foam, plastic wood, cork, or any other elastomeric material. Each pad generally includes a center hole for passage of clamp shaft 44.

As seen in FIG. 9, in some embodiments, energy supply line 36 extends through axial bore 46. In such embodiments, energy supply line 36 may be coupled to an external energy source such as a fuel tank or an electrical outlet. However, in some applications, it may be desirable to terminate energy supply line 36 at the lower end of clamp shaft 44 such that energy supply line 36 does not freely extend from the lower end of clamp shaft 44. For example, as seen in FIG. 1 and FIG. 4, a connector 62 may be positioned at the lower end of clamp shaft 44. Connector 62 may include an electrical plug connector or a gas or liquid fuel connector in various embodiments. Connector 62 is coupled to energy supply line 36 inside axial bore 46. By providing a connector 62 at the lower end of clamp shaft 44, the energy supply line 36 extending between heating unit 14 and connector 62 may be completely housed, or enclosed, within support pole 12 and clamp shaft 44.

Connector 62 provides a location for coupling heating apparatus 10 to an external energy source such as a fuel tank or an electrical outlet. Connector 62 in some embodiments includes a bulkhead connector, as seen in FIG. 11. The bulkhead connector 62 allows an external line 56 to be coupled to energy supply line 36. External line 56 may include an external line adapter 58 configured for engagement with connector 62. Similarly, energy supply line 36 includes an energy supply line adapter 90 configured for attachment to connector 62 inside axial bore 46. As such, connector 62 provides an electrical or fluid (gas or liquid) transport coupling between external line 56 and energy supply line 36.

In some embodiments where connector 62 includes a bulkhead fitting, it may be necessary to provide a transverse member for mounting the connector such that the connector 62 does not protrude radially beyond the outer diameter of clamp shaft 44. Connector 62 may be described as an axial connector in some embodiments wherein the connector 62 extends substantially axially from clamp shaft 44.

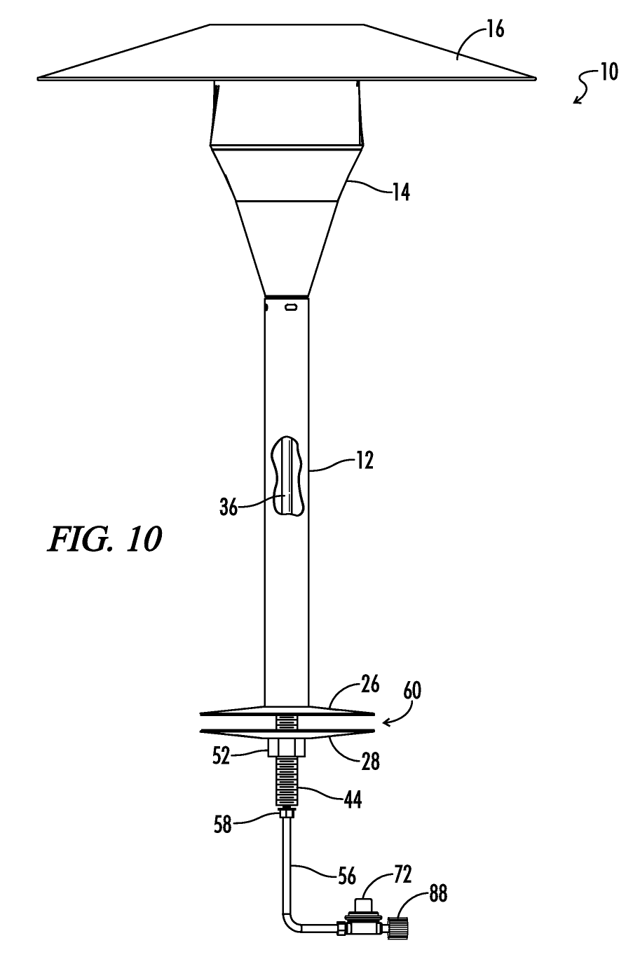

A shaft cap 82 may be installed on the lower end of clamp shaft 44 after clamp shaft 44 has been inserted through hole 24 and after clamp fastener 52 has be positioned on clamp shaft 44. Shaft cap 82 includes a transverse cap wall 86 partially blocking the opening in the axial bore 46 at the lower end of clamp shaft 44. Connector 62 may be installed through a hole in shaft cap wall 86. A bulkhead nut 82, seen in FIG. 3 may be used to secure bulkhead connector 62 on shaft cap 82. As seen in FIG. 10, in some embodiments, an external line 56 includes a gas hose attached to a valve 72 and a tank fitting 88. Tank fitting 88 is configured for attachment to an energy source 74 in the form of a conventional propane tank, as seen in FIG. 2. In other embodiments, external line 56 includes an electrical line.

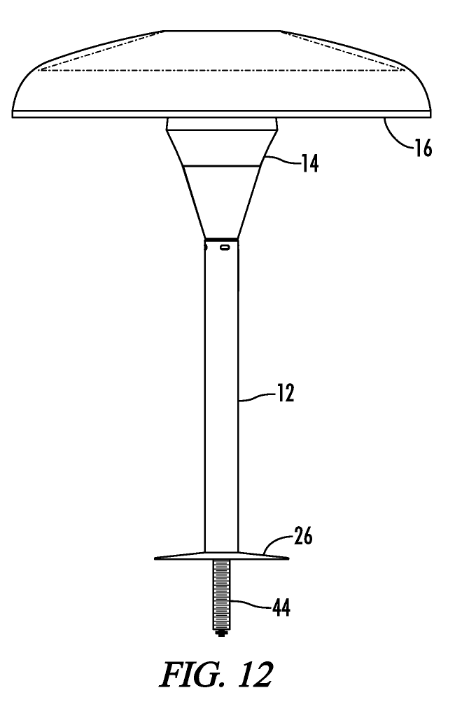

As discussed above, a heating apparatus includes a deflector 16 shaped to deflect heat downwardly toward tabletop 20. Conventional deflectors for patio heaters are generally configured to disperse radially outwardly to cover a large area. However, in some applications, it is more desirable to deflect heat downwardly over a smaller area such as a tabletop. As seen in FIG. 12, deflector 16 may include a curved profile having an outer edge substantially angled toward the tabletop 20 for deflecting heat axially downwardly toward the tabletop.

In some embodiments, a heating apparatus in accordance with the present disclosure may be installed onto a tabletop by inserting clamp shaft 44 through the opening in the tabletop 20, wherein clamp shaft 44 extends from support pole 12 at the time of insertion. However, in other embodiments, it may be desirable to attach a mounting apparatus to tabletop 20, and subsequently attaching support pole 12 directly to the mounting apparatus. For example, as seen in FIG. 17, a first clamp plate 26 includes a clamp head 42 extending upwardly therefrom. Clamp head 42 forms a generally cylindrical shape in some embodiments. First clamp plate 26 may be secured to tabletop 20 using second clamp plate 28 attached to clamp post 44 on the opposite side of tabletop 20, as seen in FIG. 13. After first clamp plate 26 has been secured to tabletop 20, support pole 12 may be mounted onto clamp head 42 by sliding tubular support pole 12 onto clamp head from above, as seen in FIG. 17. One or more pole fasteners 70a, 70b may inserted through predefined holes in support pole 12 into clamp head 42 for securing support pole 12 onto clamp head 42. As such, heating unit 10 may be installed onto tabletop 20.

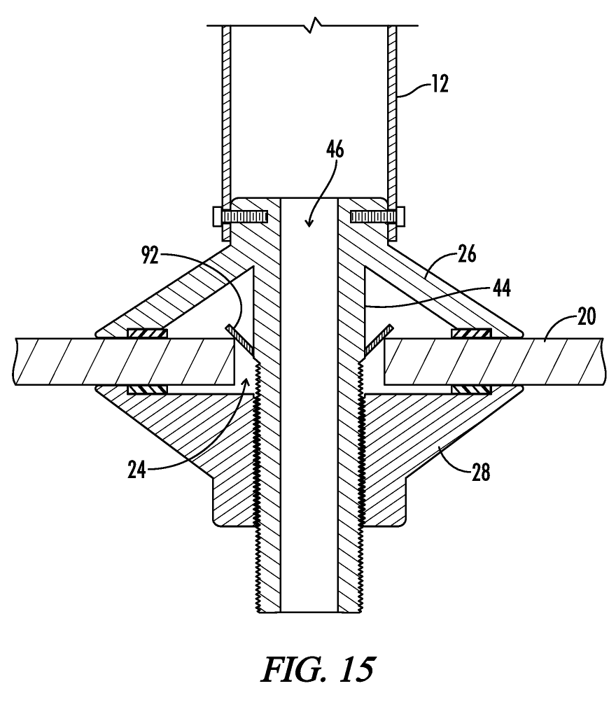

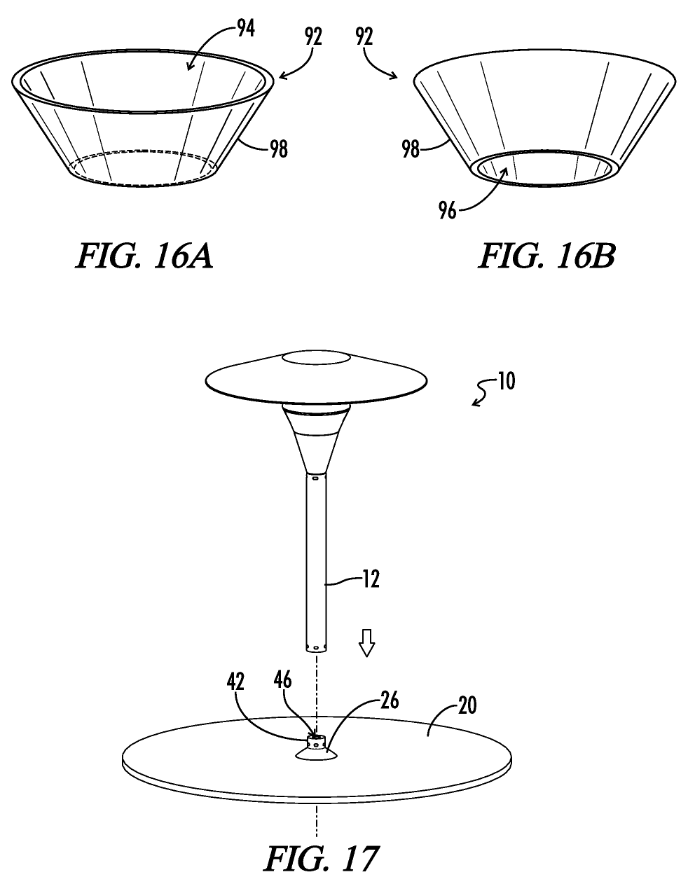

In some embodiments, first clamp plate 26 is angled relative to clamp shaft 44, as seen in FIG. 13. In such embodiments, first clamp plate 26 may resiliently flex when first and second clamp plates are tightened against tabletop 20, thereby providing additional resilient axial clamping force against tabletop 20. Also seen in FIG. 13, in some embodiments, the inner diameter of hole 24 may be close to the same outer diameter as clamp shaft 44, thereby providing close fit between hole 24 and clamp shaft 44. In some embodiments, hole 24 may include a standard hole diameter. Patio tables generally include a hole 24 having an inner diameter between about 1.5 inches and about 2.0 inches. The present disclosure provides an apparatus that may be interchangeably used with patio tables having differently sized holes 24 by using a centering cone 92, seen in FIGS. 16A and 16B. Centering cone 92 includes an angled axisymmetric cone wall 98, a top opening 94 and a bottom opening 96. In some embodiments, the outer diameter of centering cone 92 at top opening 94 is greater than the inner diameter of the largest standard hole 24 size. Similarly, the outer diameter of centering cone 92 at bottom opening 96 is less than the inner diameter of the smallest standard hole 24 size. As such, centering cone 92 may be positioned to rest in hole 24 prior to insertion of clamp shaft 44, as seen in FIG. 15. When hole 24 is larger than clamp shaft 44 centering cone 92 allows clamp shaft 44 to be centered in hole 24 for stabilizing the apparatus. In some embodiments, the outer diameter of clamp shaft 44 is substantially the same or slightly less than the inner diameter of centering cone 92 at bottom opening 96.

Also seen in FIG. 14 and FIG. 15, in some embodiments, first and second pads 32, 34 may be used with first and second clamp plates 26, 28 with or without the use of centering cone 92.

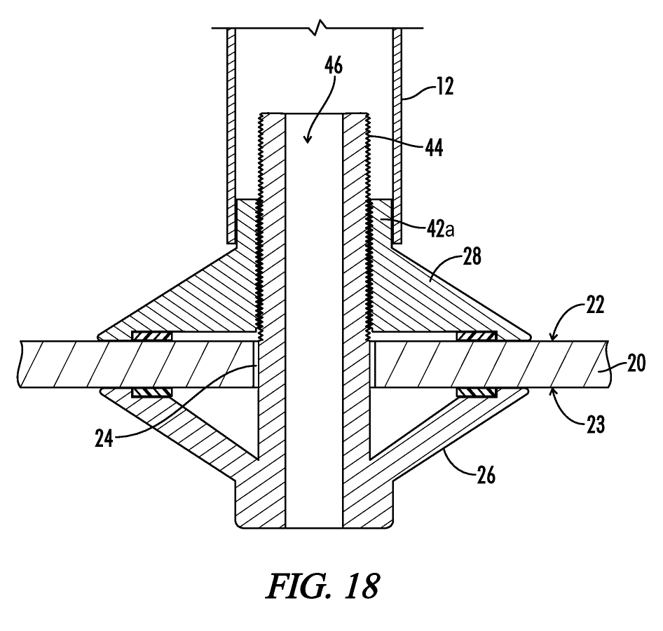

Referring now to FIG. 18, in some embodiments, clamp shaft 44 extends upwardly from first clamp plate 26 engaging second surface 23 on tabletop 20. In such embodiments, second clamp plate 28 includes a mounting head 42a for mounting support pole 12. In such embodiments, clamp shaft 44 extends upwardly from the bottom of tabletop 20 through opening 24 and threadedly engages a threaded second clamp plate aperture on second clamp plate 28. The first surface 22 of the tabletop 20 may be on the underside of the tabletop 20, and the second surface 23 may be described as on the upper surface of the tabletop 20 in some applications.

Thus, although there have been described particular embodiments of the present invention of a new and useful Mounting Apparatus for Attaching a Heating Device to a Tabletop, it is not intended that such references be construed as limitations upon the scope of this invention except as set forth in the following claims.

1. An apparatus for mounting a heating unit to a tabletop, the tabletop having a first surface and a second surface, the tabletop including a hole extending through the tabletop from the first surface to the second surface, the apparatus comprising:
a support pole having an upper end adapted to support the heating unit and a lower end extending downwardly toward the tabletop;
an opening defined in the lower end of the support pole;
a first clamp plate having a larger outer dimension than the diameter of the support pole;
a clamping post including a mounting head extending upwardly away from the tabletop, the mounting head shaped to be inserted in the opening in the lower end of the support pole;
the clamping post including a clamp shaft extending axially from the mounting head, the clamp shaft being shaped for insertion through the hole in the tabletop;
an axial bore defined through the clamp shaft;
a second clamp plate configured for attachment to the clamp shaft, the second clamp plate having a larger outer dimension than the inner diameter of the hole; and
a second clamp plate aperture defined through the second clamp plate, the second clamp plate aperture shaped for receiving the clamp shaft,
wherein the first and second clamp plates are configured to apply compressive force against the tabletop.

2. The apparatus of claim 1, wherein the clamp shaft extends through the aperture and extends below the second clamp plate.

3. (canceled)

4. The apparatus of claim 1, wherein the second clamp plate aperture includes a threaded region configured to threadedly engage the shaft thread.

5. (canceled)

6. (canceled)

7. The apparatus of claim 1, wherein the clamp shaft and the first clamp plate include a unitary construction.

8. The apparatus of claim 1, further comprising:
a clamp fastener disposed on the clamp shaft below the second clamp plate.

9. The apparatus of claim 8, further comprising:
wherein the clamp fastener includes a threaded nut.

10. (canceled)

11. (canceled)

12. (canceled)

13. The apparatus of claim 1, further comprising:
a shaft cap disposed on the lower end of the clamp shaft; and
a connector attached to the shaft cap.

14. The apparatus of claim 13, further comprising:
an energy supply line extending into the axial bore, the energy supply line coupled to the connector.

15. (canceled)

16. (canceled)

17. (canceled)

18. (canceled)

19. (canceled)

20. (canceled)

21. A heater apparatus for mounting on a tabletop, the tabletop having a hole defined through the tabletop, the apparatus comprising:
a heating unit;
a support pole having an upper end attached to the heating unit and a lower end extending downwardly away from the heating unit, the support pole defining a hollow interior region and an opening at the lower end of the support pole; and
a clamping post including a mounting head shaped to fit inside the opening at the lower end of the support pole and a clamp shaft protruding downwardly from the mounting head, the clamp shaft shaped for insertion through the hole;
wherein the support pole is securable directly to the mounting head.

22. The apparatus of claim 21, further comprising a first clamp plate disposed on the clamping post, the first clamp plate having a larger outer dimension than the support pole and configured to be clamped between the mounting head and the upper surface of the tabletop.

23. The apparatus of claim 22, further comprising:
a second clamp plate disposed on the clamping post below the first clamp plate, the second clamp plate having a larger outer dimension than the hole,
wherein the first and second clamp plates are adapted to apply compressive force against the tabletop when the tabletop is positioned between the first and second clamp plates.

24. The apparatus of claim 22, wherein the clamp shaft and first clamp plate are integrally formed in a unitary construction.

25. The apparatus of claim 23, further comprising a clamp fastener disposed on the clamp shaft below the second clamp plate.

26. The apparatus of claim 25, wherein the clamp fastener is integrally formed on the second clamp plate in a unitary construction.

27. The apparatus of claim 26, further comprising an axial bore defined through the clamp shaft.

28. The apparatus of claim 27, further comprising:
an energy supply line extending from the heating unit through the axial bore;
the clamp shaft having a lower end projecting away from the tabletop below the tabletop; and
a connector positioned at the lower end of the clamp shaft,
wherein the energy supply line is coupled to the connector.

29. (canceled)

30. The apparatus of claim 21, further comprising a centering cone disposed about the clamp shaft.

31. A method of attaching a heater apparatus to a tabletop, the tabletop including a hole, the method comprising the steps of:
(a) providing a heater apparatus including a heating unit attached to a support pole, the support pole having an opening defined in its lower end and a clamp post securable to the lower end of the support pole, the clamp post including a mounting head securable directly to the support pole by insertion of the mounting head in the opening in the lower end of the support pole, the clamp post including a clamp shaft protruding downwardly from the mounting head in a direction away from the support pole;
(b) inserting the clamp shaft through the hole in the tabletop such that the mounting head extends above the table and the clamp shaft extends through the hole below the tabletop; and
(c) installing the support pole on the clamp post by positioning the mounting head in the opening in the lower end of the support pole.

32. The method of claim 31, further comprising:
securing a clamp fastener on the portion of the clamp shaft extending below the tabletop.
